(19) United States
(12) Patent Application Publication
(10) Pub. No.: US 2026/0086781 A1
(43) Pub. Date: Mar. 26, 2026

(54) SYSTEMS AND METHODS FOR AUTOMATED GENERATION OF CUSTOMER JOURNEYS

(71) Applicant: JPMORGAN CHASE BANK, N.A., New York, NY (US)

(72) Inventors: Parvathi KARANAM, New York, NY (US); Venkatakrishnarao JOGA, New York, NY (US); Jordan BALL, New York, NY (US); Sudharshan MANPADI, New York, NY (US); Eduard DUSHAK, New York, NY (US)

(21) Appl. No.: 19/337,650

(22) Filed: Sep. 23, 2025

Related U.S. Application Data
(60) Provisional application No. 63/698,254, filed on Sep. 24, 2024.

(51) Int. Cl. G06F 8/35; G06F 8/60; G06F 11/3668

(52) U.S. Cl. CPC G06F 8/35; G06F 8/60; G06F 11/3688

(57) ABSTRACT

Systems and methods for automated generation of customer journeys are disclosed. A method may include: receiving, by a computer program and from a design interface tool, an application flow for a computer application comprising a plurality of pages and a plurality of links that link the pages together graphically; traversing, by the computer program, the application flow to identify a plurality of customer journeys from the plurality of pages and the links; generating, by the computer program, a simplified file with data for the plurality of customer journeys; generating, by the computer program, code comprising scenarios and steps for the data for each of the plurality of customer journeys; and deploying, by the computer program, the steps and scenarios to a deployment environment.

### RELATED APPLICATIONS

This application claims priority to, and the benefit of, U.S. Provisional Patent Application Ser. No. 63/698,254, filed Sep. 24, 2024, the disclosure of which is hereby incorporated, by reference, in its entirety.

### BACKGROUND OF THE INVENTION

### 1. Field of the Invention

Embodiments relate to systems and methods for automated generation of customer journeys.

### 2. Description of the Related Art

Current methods for generating acceptance criteria for customer journey flows involve manual entry into software programs for issue and project tracking. Engineers often re-write these acceptance tests, leading to a loss of knowledge due to the siloed nature of these activities. Additionally, engineers have to keep up with the pace of product changes, which can be challenging.

### SUMMARY OF THE INVENTION

Systems and methods for automated generation of customer journeys are disclosed. According to an embodiment, a method may include: receiving, by a computer program and from a design interface tool, an application flow for a computer application comprising a plurality of pages and a plurality of links that link the pages together graphically; traversing, by the computer program, the application flow to identify a plurality of customer journeys from the plurality of pages and the links; generating, by the computer program, a simplified file with data for the plurality of customer journeys; generating, by the computer program, code comprising scenarios and steps from the data for each of the plurality of customer journeys; and deploying, by the computer program, the code to the computer application.

In one embodiment, the method may also include: conforming, by the computer program and using a large language model, the application flow to a template.

In one embodiment, the template may include rules for the application flow.

In one embodiment, the large language model returns modifications to the application flow.

In one embodiment, the step of traversing the application flow to identify a plurality of customer journeys from the plurality of pages and the links may include: identifying, by the computer program, actionable elements and non-actionable elements in the application flow; identifying, by the computer program, transitions between pages in the application flow; and updating, by the computer program, the plurality of customer journeys based on the actionable elements, the non-actionable elements, and the transitions.

In one embodiment, the method may also include: receiving, by the computer program, a modification to the scenarios or steps; and updating, by the computer program, the simplified file based on the modification.

In one embodiment, the method may also include: associating, by the computer program, a product taxonomy to one of the customer journeys.

In one embodiment, the method may also include: testing, by the computer program and using generative artificial intelligence, the steps and scenarios; identifying, by the computer program and using generative artificial intelligence, a gap in the steps and scenarios; receiving, by the computer program, an adjustment to the steps or scenarios; and updating, by the computer program, the simplified file with the adjustment.

According to another embodiment, a non-transitory computer readable storage medium may include instructions stored thereon, which when read and executed by one or more computer processors, cause the one or more computer processors to perform steps comprising: receiving, from a design interface tool, an application flow for a computer application comprising a plurality of pages and a plurality of links that link the pages together graphically; traversing the application flow to identify a plurality of customer journeys from the plurality of pages and the links; generating a simplified file with data for the plurality of customer journeys; generating code comprising scenarios and steps from the data for each of the plurality of customer journeys; and deploying the code to a deployment environment.

In one embodiment, the non-transitory computer readable storage medium may also include instructions stored thereon, which when read and executed by the one or more computer processors, cause the one or more computer processors to perform steps comprising: conforming, using a large language model, the application flow to a template.

In one embodiment, the template may include rules for the application flow.

In one embodiment, the large language model returns modifications to the application flow.

In one embodiment, the step of traversing the application flow to identify a plurality of customer journeys from the plurality of pages and the links may include: identifying actionable elements and non-actionable elements in the application flow; identifying transitions between pages in the application flow; and updating the plurality of customer journeys based on the actionable elements, the non-actionable elements, and the transitions.

In one embodiment, the non-transitory computer readable storage medium may also include instructions stored thereon, which when read and executed by the one or more computer processors, cause the one or more computer processors to perform steps comprising: receiving a modification to the scenarios or steps; and updating the simplified file based on the modification.

In one embodiment, the non-transitory computer readable storage medium may also include instructions stored thereon, which when read and executed by the one or more computer processors, cause the one or more computer processors to perform steps comprising: associating a product taxonomy to one of the customer journeys.

In one embodiment, the non-transitory computer readable storage medium may also include instructions stored thereon, which when read and executed by the one or more computer processors, cause the one or more computer processors to perform steps comprising: testing, using generative artificial intelligence, the steps and scenarios; identifying, using generative artificial intelligence, a gap in the steps and scenarios; receiving an adjustment to the steps or scenarios; and updating the simplified file with the adjustment.

According to another embodiment, a system may include: a backend electronic device executing a computer program; a deployment environment; and a plurality of user electronic devices. The computer program may be configured to receive, from a design interface tool, an application flow for a computer application comprising a plurality of pages and a plurality of links that link the pages together graphically, to traverse the application flow to identify a plurality of customer journeys from the plurality of pages and the links, to generate a simplified file with data for the plurality of customer journeys, to generate code comprising scenarios and steps from the data for each of the plurality of customer journeys, and to deploy the code to the deployment environment. The deployment environment may be configured to receive the steps and scenarios. The plurality of user electronic devices are configured to access and execute the steps and scenarios.

In one embodiment, the computer program may be further configured to conform, using a large language model, the application flow to a template, wherein the template may include rules for the application flow, and the large language model returns modifications to the application flow.

In one embodiment, the computer program may be configured to traverse the application flow to identify the plurality of customer journeys from the plurality of pages and the links by: identifying actionable elements and non-actionable elements in the application flow; identifying transitions between pages in the application flow; and updating the plurality of customer journeys based on the actionable elements, the non-actionable elements, and the transitions.

In one embodiment, the computer program may be further configured to receive a modification to the scenarios or steps, and to update the simplified file based on the modification.

### BRIEF DESCRIPTION OF THE DRAWINGS

For a more complete understanding of the present invention, the objects, and advantages thereof, reference is now made to the following descriptions taken in connection with the accompanying drawings in which:

FIG. 1 illustrates a system for automated generation of customer journeys according to an embodiment;

FIG. 2 illustrates a method for automated generation of customer journeys according to an embodiment;

FIGS. 3A and 3B depict an example of an application flow according to an embodiment;

FIG. 4 depicts a method for traversing an application flow according to an embodiment;

FIG. 5 depicts a method for using generative AI to test scenarios and steps of customer journeys according to an embodiment;

FIG. 6 depicts an exemplary computing system for implementing aspects of the present disclosure.

### DETAILED DESCRIPTION OF PREFERRED EMBODIMENTS

This disclosure generally relates to systems and methods for automated generation of customer journeys.

As used herein, a journey is a data flow representation presented to a customer. For example, a journey may include multiple pages that are linked together in a certain order depending on user input.

Embodiments may systemically generate customer journey acceptance criteria and tests from one or more journeys from an interface design tool, such as FIGMA. The generated tests may be curated in a test editor, such as Gherkin. This approach directly translates a specification from the interface design tool into an end-to-end journey functional test that validates the acceptance criteria. Additionally, embodiments integrate other tools to validate the interface design tool mockup against the actual page produced by developers.

Embodiments may significantly reduce the effort in creating end-to-end tests for customer journeys, may increase functional test coverage (e.g., the extent to which the software's functionality is covered by tests), may follow best practice development with Behavior Driven Development leading to reduced lead time to deliver new user interface functionality, may improve the customer experience with higher quality features and/or capabilities, may encourage standardization of business objects, further improving the customer experience.

Embodiments may facilitate the early detection of defects in an application flow. For example, generated tests can be executed as soon as code is written, allowing teams to catch bugs and issues before they propagate to later stages. This reduces the cost and effort required to fix defects, as problems are identified closer to their source.

Embodiments may provide integrated feedback loops, as developers may receive immediate feedback on their code changes, enabling rapid iterations and improvements. In addition, continuous integration and continuous deployment pipelines can run generated tests automatically, ensuring rapid validation of new features and bug fixes. The integration of design tools with test editors, and the use of artificial intelligence ensures the early detection of flaws and improved test coverage.

Embodiments may provide improved test coverage. For example, tests can be generated for a wide range of scenarios, including edge cases that might be missed in manual testing. This leads to more comprehensive test coverage and higher confidence in software quality.

Embodiments provide consistency and repeatability, which reduces human error and variability. Further, tests can be rerun as needed, supporting regression testing and continuous delivery.

By using early and automated testing, embodiments may accelerate development cycles as issues may be identified and corrected early in the development cycle. This enables faster releases by shortening the time between development and deployment.

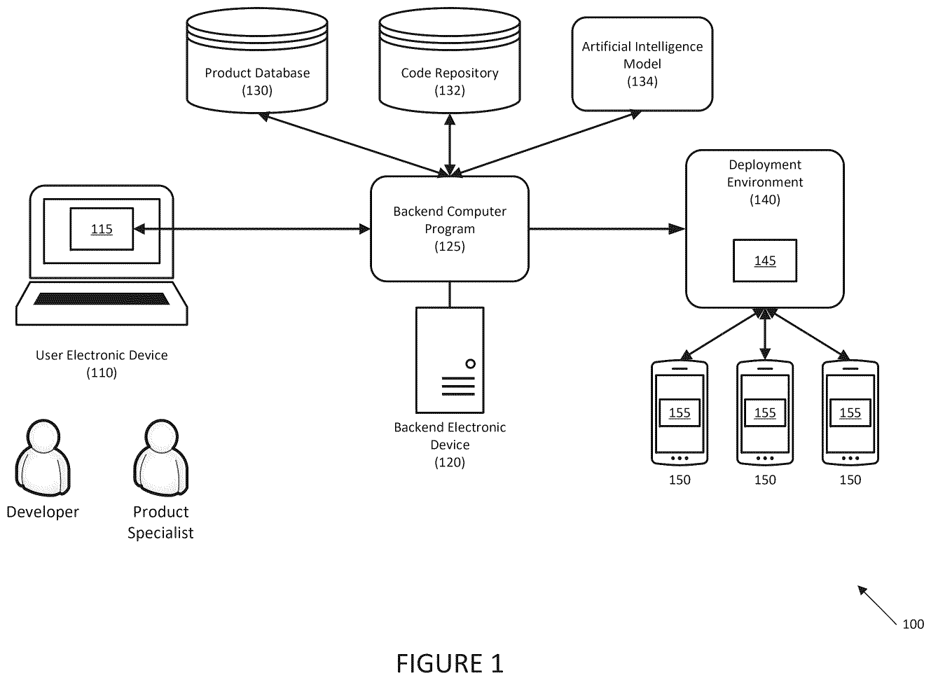

FIG. 1 illustrates a system for automated generation of customer journeys according to an embodiment. System 100 may include user electronic device 110, such as a computer (e.g., workstation, desktop, laptop, notebook, tablet, etc.), a smart device (e.g., smart phone, smart watch, etc.), an Internet of Things (IoT) appliance, etc. User electronic device 110 may execute user computer program 115, such as a computer program that receives product information, a computer program that receives design information, etc.

In one embodiment, a designer and a product specialist may each use separate user electronic devices 110.

User computer program 115 may interface with backend computer program 125 that may be executed by backend electronic device 120. Backend electronic device 120 may be a server (e.g., physical and/or cloud-based), a computer, etc. Backend computer program 125 may include one or more tools or modules, including an interface design tool, such as Figma, a web editor, such as Gherkin, project managing software, such as Jira, Bitbucket, GitHub etc.

Backend computer program 125 may also interface with database 130, which may store product information (e.g., a product type), journeys, etc.

Code may be stored, for example, in code repository 132, such as BitBucket.

Backend computer program 125 may interface with one or more artificial intelligence (AI) models 134 in order to develop the application flow and/or customer journeys. In one embodiment, one or more large language models (LLMs) may be used to test gaps in steps and scenarios. In another embodiment, in addition to or in place of LLMs, machine learning algorithms and/or rule-based systems may be used to analyze application flows and identify potential gaps or inconsistencies in the flows. The machine learning algorithms may complement LLMs by providing additional insights and validation, which enhances the overall robustness and accuracy of the automated generation of customer journeys.

In one embodiment, AI models 134 may further include Generative Artificial Intelligence (GenAI) models, which may be used to generate and optimize test scenarios, leveraging its ability to understand and predict complex patterns in user interactions. GenAI models may use patterns and rules derived from existing data to create comprehensive test cases, including typical user interactions. GenAI may also simulate various user paths and interactions, ensuring that the generated scenarios cover a wide range of possibilities.

System 100 may further include deployment environment 140 to which customer journey code 145 may be deployed. User electronic devices 150, such as mobile electronic devices, may interact with the deployed customer journey code 145 in deployment environment 140 via, for example, browsers or applications 155.

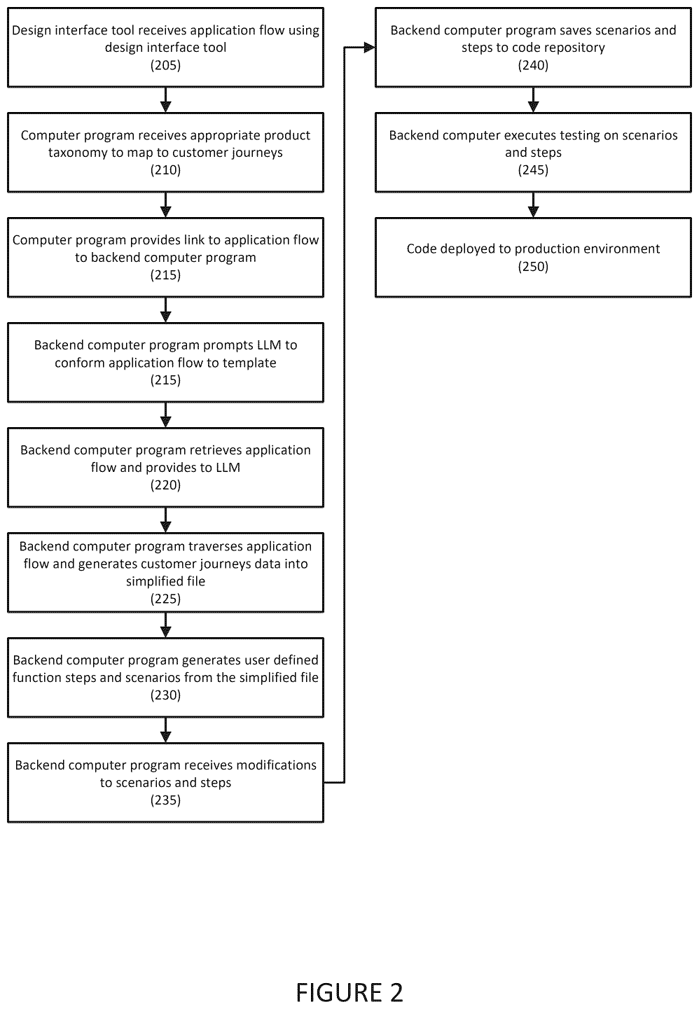

Referring to FIG. 2, a method for automated generation of customer journeys is disclosed in an embodiment.

In step 205, an interface design tool executed by an electronic device may receive an application flow from a user, such as a developer. For example, the application flow may include a plurality of pages, and certain pages may be linked together from a start page to an end page. Each path may represent a customer journey.

In one embodiment, the application flow may be generic to a plurality of products.

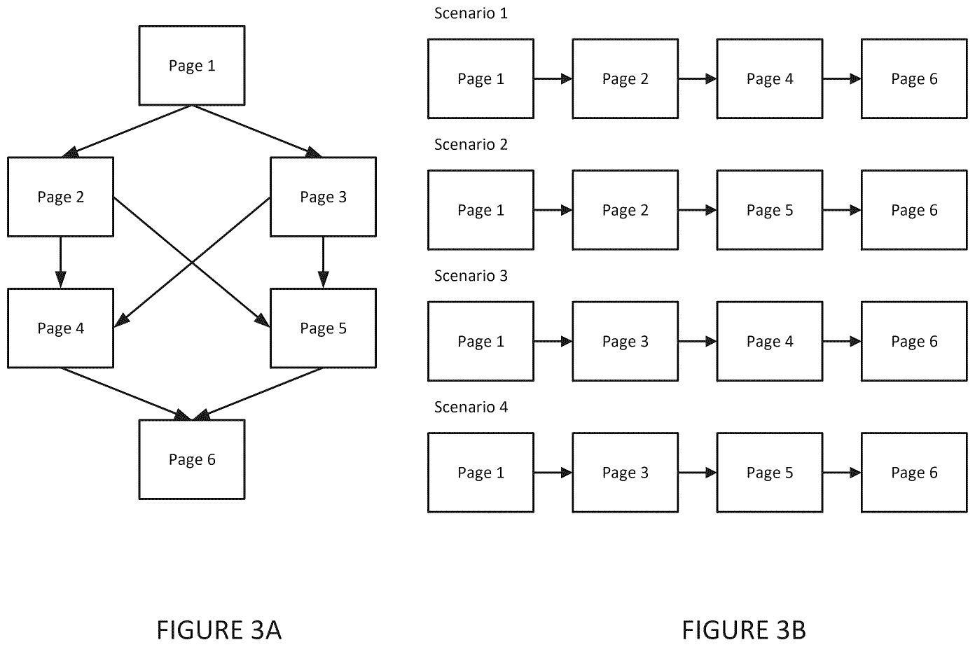

An example of an application flow is provided in FIG. 3A. As shown, the application flow may include six pages, and the links between the pages are identified. Of course, as can be appreciated by those skilled in the art, an application flow may include any number of page(s) with many possible links between the pages. Such variations and deviations are well within the scope of this disclosure.

In step 210, the interface design tool may present one or more product taxonomies to the user, and may receive a selection of one of the product taxonomies from the user. The product taxonomies may be used to map to or associate with one or more of the customer journeys. For example, all journeys related to product features and their corresponding capabilities may be grouped together in a product taxonomy. Put differently, a product taxonomy may be a functional decomposition of how products are organized within a line of business. When users are generating journeys, they can choose the taxonomy to align to the generated journeys accordingly. The product taxonomy provides a structured categorization, making it easier to manage and retrieve the relevant journeys data.

In step 215, a backend computer program executed by a backend electronic device may receive a link to the customer journeys from the interface design tool. At this point, the application flow includes the pages, the links between the pages, and the mapping to the product taxonomy.

In step 220, the backend computer program may retrieve the application flow and may provide the application flow to an artificial intelligence model, such as a LLM and/or machine learning algorithm, which may conform the application flow to a template. The template may be provided to the artificial intelligence model contemporaneous or asynchronously. For example, the backend computer program may provide the application flow and the template and may prompt the artificial intelligence model to revise the application flow to conform to the template. Additionally or alternatively, the artificial intelligence model may be provided with a template—such as during setup—prior to being provided with the application flow.

In one embodiment, the template may include a set of rules, such as no “orphan” pages, that all application flows are defined, that flow names are present, etc. Using this template, the artificial intelligence model may compare the application flow against the rules, and may suggest modifications to the application flow to meet these rules, such as adding flow names, removing orphan pages, or linking them to other pages. This process ensures that the application flow is complete, logically structured, and adheres to the required standards, thereby improving the accuracy and efficiency of generating customer journey tests.

The backend computer program may prompt the artificial intelligence model to validate a step format and ensure that a syntax is correct. As used herein, the step format may be a predefined step definition that outlines the actions and expected outcomes within each customer journey, providing a structured format for writing test scenarios that provide a structured format for writing test scenarios. Moreover, the syntax may be a specific structure and language rules used to write the step definition. The artificial intelligence model may further be prompted to validate the logical order of steps in the application flow (e.g., “Given I'm on Login page, And I enter credentials, When I click on Signin, Then I am on Dashboard page”), may be prompted to identify any redundant journeys and auto correct them (e.g. by removing or consolidating redundant journeys), may be prompted to ensure that error scenarios are covered as well, etc.

Error scenarios may be identified by analyzing the application flow for potential issues, such as missing transitions or unexpected outcomes. The artificial intelligence model may return suggested modifications to address these issues, such as adding error handling steps or refining the logic to ensure comprehensive coverage of potential error conditions. This helps in creating robust test scenarios that account for both expected and unexpected user interactions.

In step 225, the backend computer program may receive the output of the artificial intelligence model, may traverse the application flow to identify the different journeys from the links, and may generate customer journey data into a simplified file (e.g., a text-based file, such as a JSON). For example, as will be described in greater detail below, the backend computer program may start with a start page and traverse the different links between pages until the end page is reached, resulting in a plurality of customer journeys.

An example of a result of traversing the application flow is illustrated in FIG. 3B. The backend computer program may generate linear flows representing the customer journeys, and the generated customer journeys may be displayed to the end user. The linear flows may be stored in cloud storage with additional metadata, such as design link, generated journeys, user info, generation status, any errors, etc.

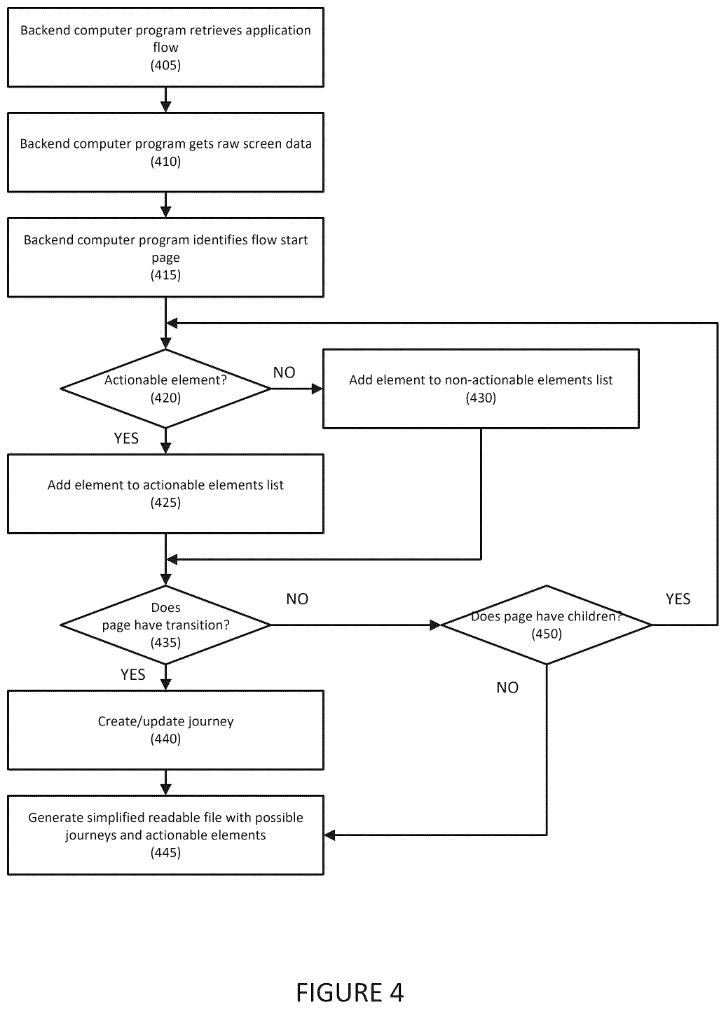

An example technique for traversing the application flow to generate a simplified file is provided in FIG. 4.

In step 405, the backend computer program may retrieve the application flow using, for example, the link provided in, for example, step 215.

In step 410, the backend computer program may extract raw page data from the application flow. The raw data may include non-graphical information, but describes how the pages are connected, the actions associated with the pages, etc. In one embodiment, the raw page data may be provided in a tree format of nodes, where each node represents a page.

In step 415, the computer program may identify a flow start page in the application flow (e.g., the top page in the application flow), and in step 420, the backend computer program may review any elements on the page, and determine if any of the elements are actionable elements. An “element” in the context of the application flow refers to any component within a page that can either cause an action or can display information. This includes both actionable elements, such as buttons or links that trigger transitions to other pages, and non-actionable elements, such as text or images that provide information without altering the flow.

If the page includes an actionable element, in step 425, the backend computer program may add the actionable element to an actionable elements list.

If the page does have an element that is not an actionable element (e.g., elements that do not modify the journey, such as elements that display certain text but do not link to other pages), in step 430, the backend computer program may add the non-actionable element to a non-actionable elements list.

In step 435, the backend computer program may determine if the page has a transition to another page, such as a movement from one page to another within the application flow. This can occur through actionable items, such as links or buttons that a user interacts with, or through automatic transitions, where a page moves to another after a certain condition is met, such as a timeout or completion of a process. Both types of transitions are considered when identifying the flow of customer journeys, ensuring comprehensive coverage of all possible navigation paths within the application.

If the page has a transition to another page, in step 440, the backend computer program may create or update the customer journey data for the customer journey using the pages, the actionable elements on the actionable elements list, the non-actionable elements from the non-actionable elements list, the transitions, etc. If the customer journey data already exists, it will be updated; otherwise, customer journey data may be created and maintained throughout the process until the entire application flow has been traversed. The customer journey data preserved during this process may subsequently be utilized to generate a simplified file (e.g., a text-based representation of the customer journeys).

In step 445, the backend computer program may generate a simplified file, such as a JSON file, with possible journeys, including the pages, the actionable elements on the actionable elements list, the non-actionable elements from the non-actionable elements list, and the transitions in the customer journey data. For example, the backend computer program may organize the customer journey data on pages, actionable elements, non-actionable elements, and transitions into a text-based format, such as JSON, which captures the essential details of each journey in a simplified and standardized manner. This file may serve as a foundation for generating test scenarios and steps, ensuring consistency and ease of use in subsequent testing processes.

If the page does not have a transition, in step 450, the backend computer program may determine if the page has any child pages by determining if there are any links from the page to another page. If it does, the process may return to step 420.

The process may be repeated for all child pages.

If the page does not have any children, the process may continue to step 445.

Returning to FIG. 2, in step 230, the backend computer program may generate code for the user defined function steps and scenarios for the customer journeys from the simplified file. For example, using the pages, the actionable elements on the actionable elements list, the non-actionable elements from the non-actionable elements list, and the transitions in the simplified file, the backend computer program may generate computer code in a specific language, such as the Gherkin Domain specific language.

In one embodiment, the backend computer program may use the information in the simplified file to generate code by mapping the structured data into the domain-specific language format. This may involve translating the pages, actionable elements, non-actionable elements, and transitions into a syntax (e.g., Gherkin's “Given-When-Then” syntax), which defines the preconditions, actions, and expected outcomes for each journey.

In one embodiment, Gherkin may be used because it supports Behavior Driven Development (BDD), allowing for clear and human-readable test scenarios that facilitate collaboration between technical and non-technical stakeholders. This approach ensures that the generated tests are both comprehensive and easily understandable, promoting effective communication and alignment across teams.

In step 235, the backend computer program may present the scenarios and steps to the user in, for example, an editor user interface, and may receive modification(s) to the scenarios and steps from the user. For example, the modifications may include additional elements (e.g., actionable and non-actionable), the removal of repeated common journeys, etc.

The computer program may then update the simplified file with the modification(s) to the application flow.

In step 240, once complete, the backend computer program may save the code for the scenarios and steps to a code repository, such as Bitbucket.

In step 245, the backend computer program may test the code by executing the code to ensure that it functions as intended and does not disrupt any existing flows. In one embodiment, the code may be executed as end-to-end testing and user acceptance testing during code integration/code deployment. The standards for ensuring that the code operates as intended may be derived from industry best practices, organizational guidelines, and specific project requirements. These standards may include, for example, coding conventions, testing protocols, and quality assurance processes that are established to ensure consistency, reliability, and functionality.

These standards for ensuring that the code operates as intended may be implemented through the use of predefined templates, validation rules, and automated testing frameworks like Gherkin, which help verify that the generated code meets the specified acceptance criteria and performs as expected in various scenarios.

In addition, as the backend computer program generates new code or updates the existing code, continuous integration pipelines may automatically run tests and validate any new features in the code, ensuring ongoing compliance with these standards.

In one embodiment, the application may be tested in a virtual environment with mock inputs and interactions.

In one embodiment, GenAI may be used to automatically generate test scenarios based on customer journey data, ensuring comprehensive coverage of edge cases and potential user interactions. GenAI may also be used to analyze the generated acceptance criteria and provide insights into test coverage and may identify gaps and suggest additional scenarios to cover untested areas.

For example, the backend computer program may use GenAI to analyze the customer journey data to automatically generate test scenarios. It may use patterns and rules derived from existing data to create comprehensive test cases, including typical user interactions and potential edge cases. GenAI can simulate various user paths and interactions, ensuring that the generated scenarios cover a wide range of possibilities.

The edge cases may be identified by GenAI through its analysis of the application flow and customer journey data. It examines potential variations and exceptions in user interactions that might not be immediately apparent. The acceptance criteria may be generated based on predefined templates and rules, which outline the expected outcomes and conditions for successful test execution. These criteria are integrated into the generated test scenarios to ensure comprehensive coverage.

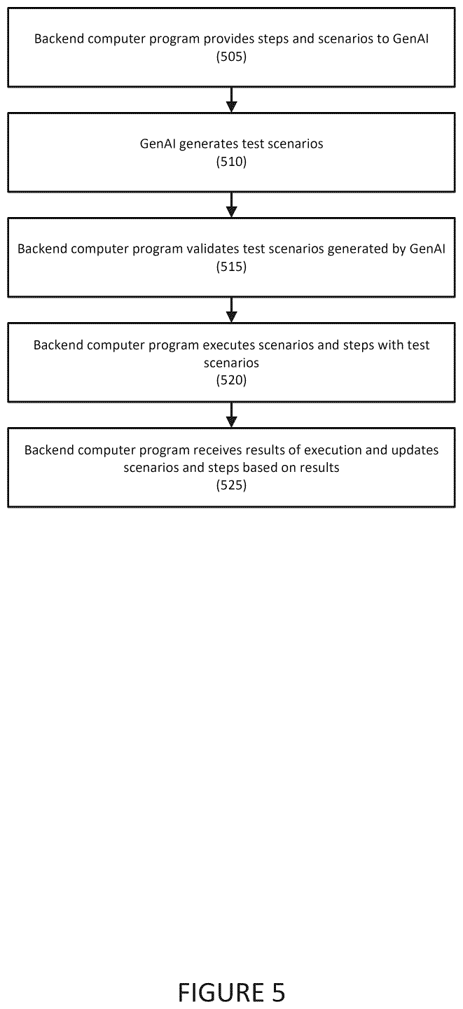

Referring to FIG. 5, a method for using GenAI to test scenarios and steps of customer journeys is provided according to an embodiment.

In step 505, the backend computer program may provide scenarios and steps for the customer journeys to a GenAI model. For example, the backend computer program may provide the scenarios and steps, the generated customer journeys, and any other information (e.g., screenshots of the execution) to the GenAI model.

In step 510, the GenAI model may generate test scenarios, including edge cases, to be used to test the scenarios and steps. For example, the GenAI model may use prompt pre-trained transformer models with this information to generate edge cases and additional test scenarios.

In one embodiment, GenAI may predict how these scenarios might behave based on historical data and learned patterns. This predictive capability helps prioritize testing efforts by identifying high-risk areas and suggesting additional scenarios to cover untested aspects.

In step 515, the backend computer program may validate the test scenarios generated by GenAI. For example, the backend computer program may evaluate the test scenarios to ensure that they meet the acceptance criteria and cover all necessary conditions.

In step 520, the backend computer program may execute the test scenarios with the scenarios and steps. In one embodiment, an automated testing framework, including a continuous integration and continuous development pipeline, may be used to execute the scenarios and steps. The automated testing framework may validate the functionality and may ensure that the scenarios and steps meet the specified acceptance criteria.

In step 525, the backend computer program may receive the results of the execution, and may update the scenarios and steps based on results as is necessary. The process may be repeated with the updated scenarios and steps.

For example, after executing the test scenarios and steps, the results may be analyzed to identify any gaps, such as failures or areas for improvement. In one embodiment, feedback on the results may be received from a human in the loop. This feedback may include suggestions for additional elements, removal of redundant journeys, or adjustments to existing steps and scenarios.

Based on the feedback, the backend computer program may process the received modifications and update the simplified file that contains the customer journey data. This involves integrating the changes into the existing scenarios and steps, ensuring that they align with the predefined templates and rules.

The process may then be repeated to ensure that the updated scenarios and steps meet the acceptance criteria and do not disrupt existing flows.

Referring again to FIG. 2, in step 250, if the testing is successful, the backend computer program may deploy the code to a production environment, where user electronic devices can access the code. For example, if the end-to-end testing, the user acceptance testing, and any other testing are successful, the code may be deployed to the production environment and made available to customers.

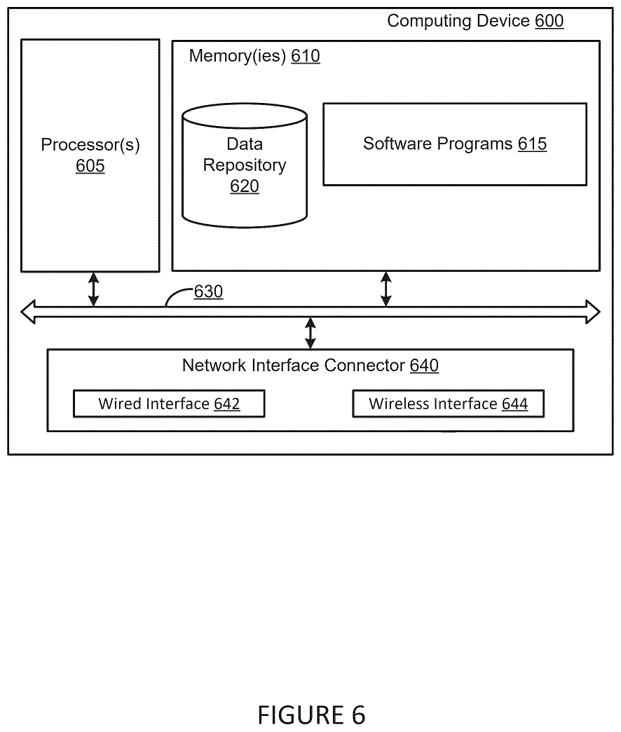

FIG. 6 depicts an exemplary computing system for implementing aspects of the present disclosure. FIG. 6 depicts exemplary computing device 600. Computing device 600 may represent the system components described herein. Computing device 600 may include processor 605 that may be coupled to memory 610. Memory 610 may include volatile memory. Processor 605 may execute computer-executable program code stored in memory 610, such as software programs 615. Software programs 615 may include one or more of the logical steps disclosed herein as a programmatic instruction, which may be executed by processor 605. Memory 610 may also include data repository 620, which may be nonvolatile memory for data persistence. Processor 605 and memory 610 may be coupled by bus 630. Bus 630 may also be coupled to one or more network interface connectors 640, such as wired network interface 642 or wireless network interface 644. Computing device 600 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program and from a design interface tool, an application flow for a computer application comprising a plurality of pages and a plurality of links that link the pages together;
traversing, by the computer program, the application flow to identify a plurality of customer journeys from the plurality of pages and the links;
generating, by the computer program, a simplified file with data for the plurality of customer journeys;
generating, by the computer program, code comprising scenarios and steps for the data for each of the plurality of customer journeys; and
deploying, by the computer program, the code to a production environment.

2. The method of claim 1, further comprising:
conforming, by the computer program and using a large language model, the application flow to a template.

3. The method of claim 2, wherein the template comprises rules for the application flow.

4. The method of claim 2, wherein the large language model returns modifications to the application flow.

5. The method of claim 1, wherein the step of traversing the application flow to identify a plurality of customer journeys from the plurality of pages and the links comprises:
identifying, by the computer program, actionable elements and non-actionable elements in the application flow;
identifying, by the computer program, transitions between pages in the application flow; and
updating, by the computer program, the plurality of customer journeys based on the actionable elements, the non-actionable elements, and the transitions.

6. The method of claim 1, further comprising:
receiving, by the computer program, a modification to the scenarios or steps; and
updating, by the computer program, the simplified file based on the modification.

7. The method of claim 1, further comprising:
associating, by the computer program, a product taxonomy to one of the customer journeys.

8. The method of claim 1, further comprising:
testing, by the computer program and using generative artificial intelligence, the steps and scenarios;
identifying, by the computer program and using generative artificial intelligence, a gap in the steps and scenarios;
receiving, by the computer program, an adjustment to the steps or scenarios; and
updating, by the computer program, the simplified file with the adjustment.

9. A non-transitory computer readable storage medium, including instructions stored thereon, which when read and executed by one or more computer processors, cause the one or more computer processors to perform steps comprising:
receiving, from a design interface tool, an application flow for a computer application comprising a plurality of pages and a plurality of links that link the pages together graphically;
traversing the application flow to identify a plurality of customer journeys from the plurality of pages and the links;
generating a simplified file with data for the plurality of customer journeys;
generating code comprising scenarios and steps for the data for each of the plurality of customer journeys; and
deploying the code to a production environment.

10. The non-transitory computer readable storage medium of claim 9, further including instructions stored thereon, which when read and executed by the one or more computer processors, cause the one or more computer processors to perform steps comprising:
conforming, using a large language model, the application flow to a template.

11. The non-transitory computer readable storage medium of claim 10, wherein the template comprises rules for the application flow.

12. The non-transitory computer readable storage medium of claim 10, wherein the large language model returns modifications to the application flow.

13. The non-transitory computer readable storage medium of claim 9, wherein the step of traversing the application flow to identify a plurality of customer journeys from the plurality of pages and the links comprises:
identifying actionable elements and non-actionable elements in the application flow;
identifying transitions between pages in the application flow; and
updating the plurality of customer journeys based on the actionable elements, the non-actionable elements, and the transitions.

14. The non-transitory computer readable storage medium of claim 9, further including instructions stored thereon, which when read and executed by the one or more computer processors, cause the one or more computer processors to perform steps comprising:
receiving a modification to the scenarios or steps; and
updating the simplified file based on the modification.

15. The non-transitory computer readable storage medium of claim 9, further including instructions stored thereon, which when read and executed by the one or more computer processors, cause the one or more computer processors to perform steps comprising:
associating a product taxonomy to one of the customer journeys.

16. The non-transitory computer readable storage medium of claim 9, further including instructions stored thereon, which when read and executed by the one or more computer processors, cause the one or more computer processors to perform steps comprising:
testing, using generative artificial intelligence, the steps and scenarios;
identifying, using generative artificial intelligence, a gap in the steps and scenarios;
receiving an adjustment to the steps or scenarios; and
updating the simplified file with the adjustment.

17. A system, comprising:
a backend electronic device executing a computer program;
a production environment; and
a plurality of user electronic devices;
wherein:
the computer program is configured to receive, from a design interface tool, an application flow for a computer application comprising a plurality of pages and a plurality of links that link the pages together graphically, to traverse the application flow to identify a plurality of customer journeys from the plurality of pages and the links, to generate a simplified file with data for the plurality of customer journeys, to generate code comprising scenarios and steps for the data for each of the plurality of customer journeys, and to deploy the code to the deployment environment;
the deployment environment is configured to receive the steps and scenarios; and
the plurality of user electronic devices are configured to access and execute the steps and scenarios.

18. The system of claim 17, wherein the computer program is further configured to conform, using a large language model, the application flow to a template, wherein the template comprises rules for the application flow, and the large language model returns modifications to the application flow.

19. The system of claim 17, wherein the computer program is configured to traverse the application flow to identify the plurality of customer journeys from the plurality of pages and the links by: identifying actionable elements and non-actionable elements in the application flow; identifying transitions between pages in the application flow; and updating the plurality of customer journeys based on the actionable elements, the non-actionable elements, and the transitions.

20. The system of claim 17, wherein the computer program is further configured to receive a modification to the scenarios or steps, and to update the simplified file based on the modification.
